(19) United States
(12) Patent Application Publication
(10) Pub. No.: US 2020/0223049 A1
(43) Pub. Date: Jul. 16, 2020

(54) IMPACT TOOL FOR MACHINING WORKPIECES

(71) Applicant: Pitec Deutschland GmbH, Duisburg (DE)

(72) Inventor: Erwin SCHMUCKER, Schelklingen (DE)

(73) Assignee: Pitec Deutschland GmbH, Duisburg (DE)

(21) Appl. No.: 16/648,382

(22) PCT Filed: Sep. 19, 2018
(86) PCT No.: PCT/EP2018/075302

§ 371 Date: Mar. 18, 2020

(30) Foreign Application Priority Data
Sep. 19, 2017 (DE) 10 2017 121 668.5

(51) Int. Cl. B25D 17/24; B25D 17/06

(52) U.S. Cl. CPC B25D 17/24; B25D 17/043; B25D 17/06

(57) ABSTRACT

An impact tool for machining workpieces has an impact mechanism which is arranged in a housing and is suitable for transmitting an oscillating movement to a machining tip arranged in an axial direction, wherein the impact mechanism can be displaced against the housing between a lower stop point and an upper stop point in the axial direction, wherein a device for generating a constant or variable contact pressure of the machining tip is arranged between the housing and the impact mechanism, such that after a prestressing path of the impact mechanism from the lower stop point, the machining tip is additionally subjected to the contact pressure.

The invention relates to an impact tool for machining workpieces.

It is known from the general prior art that high-frequency hammering can increase the lifespan of mechanical components and systems. An improved vibration resistance or fatigue life has been determined in the case of dynamically loaded constructions. The cause of stress corrosion cracking is reduced or avoided by superimposing tensile residual stresses with compressive residual stresses on the material surface. There is also a reduction in the shrinkage stresses and consequently the distortion due to the hammering of every layer of weld seams.

Such a device is shown for example in WO 2009/003790 A1. This document shows an apparatus for machining workpieces, in particular for impact machining, which is equipped with a drive device in a housing base body and a tool arrangement which can be actuated by the latter. The drive device contains, as an actuator, an elongated hollow body which can be pressurized with compressed air, said hollow body having a cavity which is laterally closed off by a flexible membrane between two end bodies arranged at a distance from one another in a longitudinal direction and, as compressed air is fed into the cavity and the membrane is widened laterally, the distance between the end bodies is shortened, thereby causing a driving force. The supply of compressed air into the cavity can be controlled in time via a controllable valve arrangement of the apparatus, wherein the pressure and cycle frequency for the supply of compressed air can be independently selected.

A pneumatic actuator is known from US 2004/0123732 A1. The actuator has an outer housing and a typically pneumatic fluidic muscle mounted within the outer housing, wherein an annular space is defined between the fluidic muscle and the outer housing. Fluid connections, i.e. usually air openings, are provided in order to set the fluidic muscle and the annular space to a pressure above the ambient pressure, whereby the fluidic muscle can generate an actuating movement by releasing pressure from the annular space.

DE 3402010 A1 describes a working device which should make the work of removing rust from iron plates and other iron structures considerably easier. Rust is removed with the help of a few small hammers that are guided in parallel and knock against the surface from which rust is to be removed. The small hammers are driven by means of an electric motor which is either integrated into the working device or is located in another working device, for example an electric hand drill, to which the device containing the small hammers is fastened. The working device expediently contains a motor-driven control roller which periodically displaces the small hammers by turns, which takes place against the force of a spring, so that the small hammers are pressed against the surface by said force.

Based on this prior art, the inventor has now set himself the task of further improving an impact tool for machining workpieces, in particular in such a way that it can be used, for example, with an industrial robot.

This object is achieved by the features of claim 1. Further advantageous embodiments of the invention are the subject matter of the dependent claims. These can be combined in a technologically meaningful way. The description, in particular in connection with the drawing, additionally characterizes and specifies the invention.

According to the invention, an impact tool for machining workpieces is specified having an impact mechanism which is arranged in a housing and is suitable for transmitting an oscillating movement to a machining tip arranged in an axial direction, wherein the impact mechanism can be displaced against the housing between a lower stop point and an upper stop point in the axial direction, wherein a means for generating a constant or variable contact pressure of the machining tip is arranged between the housing and the impact mechanism, such that after a prestressing path of the impact mechanism from the lower stop point, the machining tip is additionally subjected to the contact pressure.

While in the previously known apparatuses the contact pressure had to be provided by a user, a structure is now selected according to the invention in which a means for generating the contact pressure is arranged between the housing and the impact mechanism. Consequently, the user, who is usually connected to the impact tool via the housing, can perform a holding function, but the contact pressure can be transferred to the machining tip independently of the holding function by the means for generating the contact pressure. For example, an industrial robot having an arm able to hold the impact tool according to the invention could guide the impact tool according to the invention to the surface to be machined, while the means for generating the contact pressure acts on the machining tip for the respective application using a corresponding contact pressure. In addition to use with industrial robots, such a procedure is also advantageous for human users, since the impact force is determined by the impact tool itself, such that it can also be used by inexperienced users. The contact pressure is generated by displacing the impact mechanism from the lower stop point by a prestressing path. The area in which the impact tool can be used extends up to an area just before the upper stop point.

According to one embodiment of the invention, a holding means, preferably in the form of a handle or a fastening receptacle, for generating a holding force, is arranged on the side opposite the machining tip and is connected to the housing.

The holding force, which acts, for example, on a handle by a user or on a fastening receptacle by a robot, serves to spatially fix the impact tool. However, the holding force has no influence or only an influence on the contact pressure that can be predetermined according to the configuration of the means for generating the contact pressure, since the contact pressure can be determined, for example, by a path-dependent or path-independent spring force. Accordingly, the means for generating the contact pressure decouples it from the holding force. By means of the holding means, the holding force is required by the user or the robot, which causes the impact mechanism to be displaced by the prestressing path from the lower stop point.

According to a further embodiment of the invention, the means for generating the contact pressure is arranged on the opposite side of the housing with respect to the holding means.

This allows for a compact structure of the impact tool, wherein the holding means act in a simple manner on the means for generating the contact pressure in order to produce the displacement of the impact mechanism by the prestressing path.

According to a further embodiment of the invention, the impact mechanism is designed as a pneumatic muscle or membrane, has a magnetic or piezoelectric drive, or is designed in the form of an air piston.

Accordingly, different impact mechanisms can be used, which can be selected depending on the application. For example, the use of a pneumatic muscle would require a narrow but relatively elongated shape of the housing, while the use of a pneumatic membrane could have a shape of the housing with a larger diameter but less height. Depending on the workpiece to be machined or the application, suitably dimensioned impact tools can therefore be provided which are designed with the design of the contact pressure according to the invention. The selection can also be made depending on which form of energy is available at the place of use or is allowed at the place of use for safety reasons.

The means for generating the contact pressure can be provided with a mechanical, piezoelectric, a magnetic, or a hydraulic spring element or can be pneumatic in the form of an air spring.

In the case of a pneumatic design of the impact mechanism, the means for generating the contact pressure is preferably also designed pneumatically in the form of an air spring. In all of the drive types mentioned, adjustability can be done either manually or automatically. In the case of a mechanical spring element, the prestress can be changed in a simple manner by means of an adjustable turntable. The selection with regard to the spring element can, as already described above in connection with the drive of the impact mechanism, be dependent on which form of energy is available at the place of use or is permitted at the place of use for safety reasons.

According to a further embodiment of the invention, the means for generating the contact pressure can be regulated via a control circuit. In this case, an inclination sensor can be provided, which can transmit a spatial orientation of the impact tool to the control circuit, so that a constant application of force to the machining tip can be generated regardless of the spatial orientation of the impact tool.

The controllability of the means for generating the contact pressure is advantageous in several respects. For example, the control circuit can be designed such that the spring element generates a constant or as constant as possible contact pressure. In the case of automated machining by means of a robot or robot arm in particular, the control circuit can also be supplied with the current coordinates of the machining path, so that a path-dependent contact pressure can be generated from this, for example. Furthermore, a spatial orientation of the impact tool can also be determined from the current coordinates of the machining path or by means of the inclination sensor, so that the weight force of the impact tool, which acts differently depending on the spatial orientation, or the frictional force of the impact mechanism can be compensated. This simplifies the manual machining of workpieces in changing locations, even overhead. With automated machining using a robot or robot arm, this procedure allows for reproducible machining. The control circuit is therefore able to compensate for varying distances between the workpiece and the machining tip and/or is able to compensate for otherwise varying contact pressures.

According to a further embodiment of the invention, one or more optical, electrical, or acoustic displays of the prestressing path are provided within the lower stop point and the upper stop point.

The impact mechanism is displaced in the housing between the lower stop point and the upper stop point, whereby machining is possible after reaching a minimal prestressing path until shortly before reaching the upper stop point. Adherence to the optimal work area within this distance can be conveyed by one or more optical, electrical, or acoustic displays. The user can be shown the correct prestress by a light-emitting diode using a first color. For example, if the holding force is too high, the prestressing path is increasingly displaced towards the upper stop point, which could be indicated by a light-emitting diode using a second color in case a certain limit is reached. Alternatively or additionally, this can also be done acoustically. Likewise, instead of or in addition, an electrical signal can be generated which can be further processed by a control circuit, for example a robot or a robot arm.

According to a further embodiment of the invention, the impact tool has an automatic start circuit, which activates the impact mechanism when a specified minimal prestressing path is reached. In this case, a hand switch can be provided which can overwrite the automatic start circuit with regard to switching off the impact mechanism.

This procedure allows the hammer mechanism to be started automatically when the specified minimal prestressing path is reached, which in particular significantly simplifies the machining of workpieces by a user, since no active action beyond the generation of the holding force is now required, in such a way that the user can concentrate on the correct positioning of the impact tool. When machining edges or around edges, however, it may be necessary to briefly set down the impact tool, so that the determined minimal prestressing path is undershot. However, immediately switching off and then switching on the impact mechanism would be disruptive, so that the automatic start can be designed as to be overwritten using the hand switch. Such overwriting can also be linked to a time window, so that the hammer mechanism can only be prevented from being switched off for a predetermined period of time. When machining by means of a robot or robot arm, this can also be stored in the path program of the machining path and can be emitted as an electrical signal which replaces the actuation of the hand switch.

According to a further embodiment of the invention, the impact mechanism is provided with at least one supply line, which generates the oscillating movement via a suitable control. The supply line can be displaced relative to the housing together with the impact mechanism or can be fixed relative to the housing. In the latter case, the supply line can be connected to an opening on the housing, which can open into a preferably annular receptacle arranged in the axial direction on the impact tool, which is dimensioned such that an uninterrupted connection with the supply line between the lower stop point and the upper stop point is achievable.

The supply line can be designed as a fluid line in the case of a hydraulic or pneumatic impact mechanism. This can either be connected directly to the impact mechanism so that it follows the movement of the impact mechanism relative to the housing at the connection point to the impact mechanism, or else it can be fixedly mounted on the housing. In the latter case, the annular receptacle can ensure an uninterrupted connection to the supply line without having to provide flexible line portions or the like in the interior of the housing. In this way, a compact structure of the impact tool can be achieved.

Some embodiments are explained in more detail below with reference to the drawings. In the drawings:

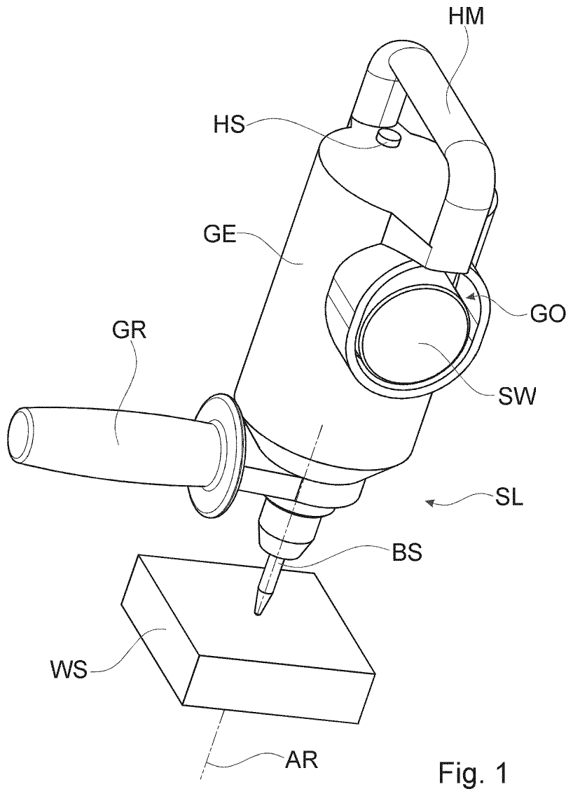

FIG. 1 is a perspective side view of an impact tool of the invention according to a first embodiment,

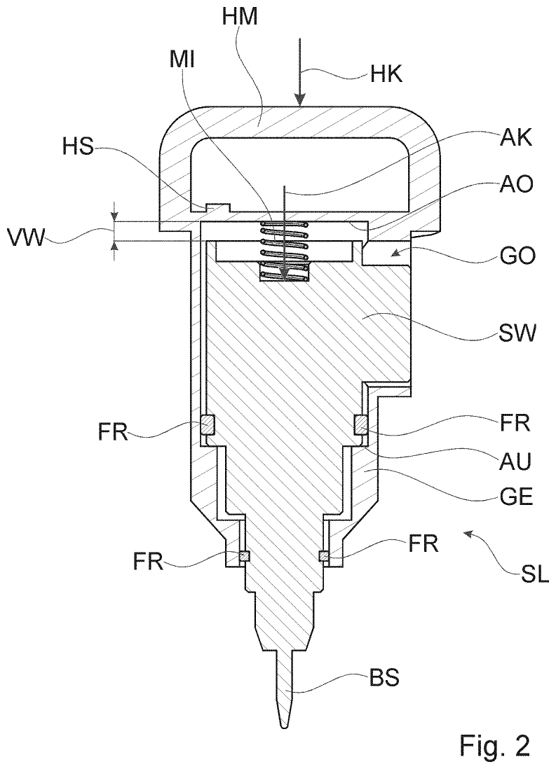

FIG. 2 is a sectional view of the impact tool from FIG. 1,

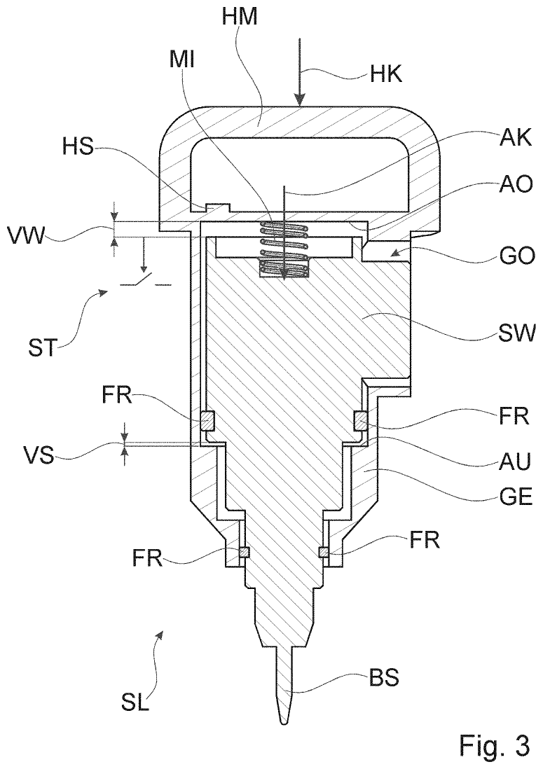

FIG. 3 is the impact tool from FIG. 1 in a first position of the impact mechanism in a sectional view,

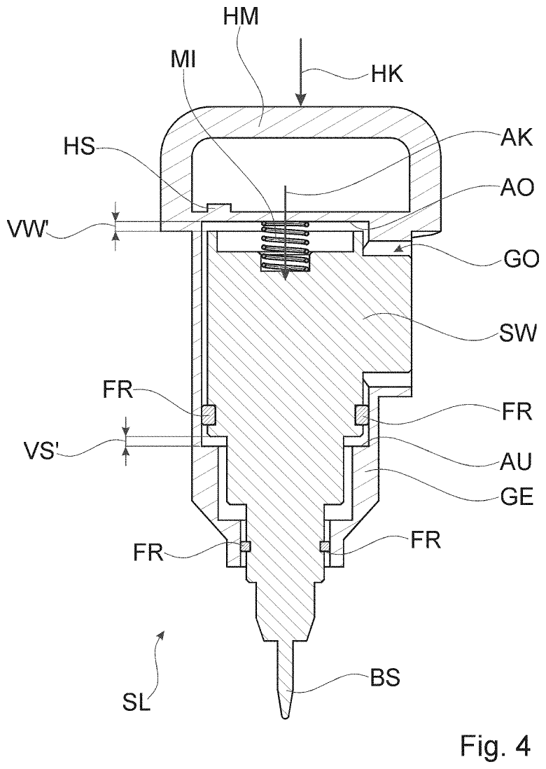

FIG. 4 is the impact tool from FIG. 1 in a second position of the impact mechanism in a sectional view,

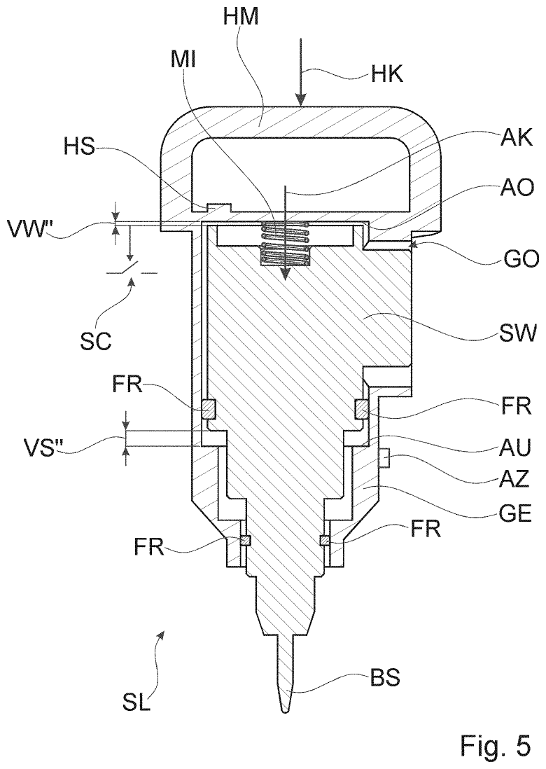

FIG. 5 is the impact tool from FIG. 1 in a third position of the impact mechanism in a sectional view,

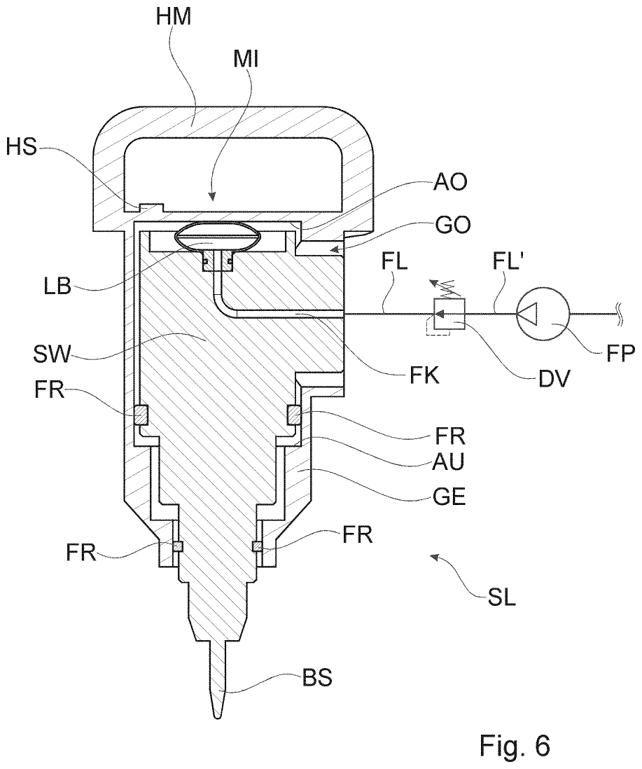

FIG. 6 is a sectional view of an impact tool according to the invention according to a second embodiment,

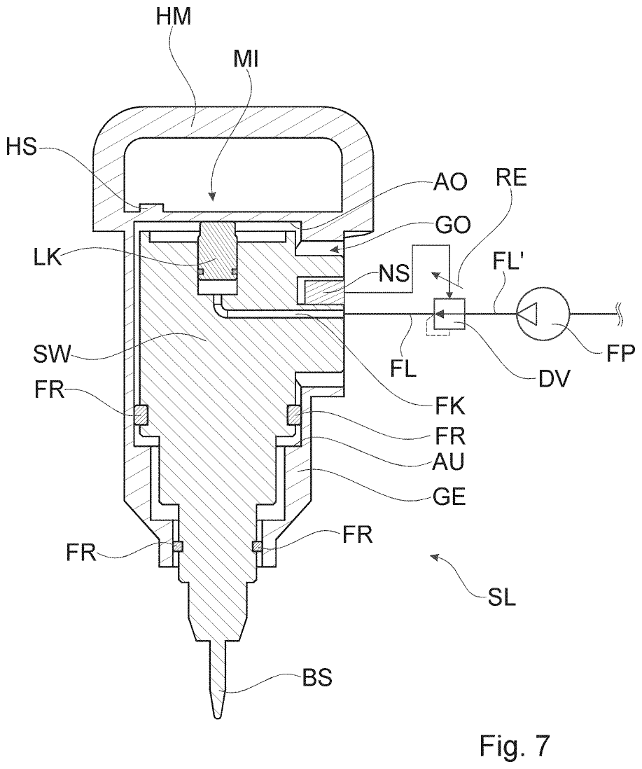

FIG. 7 is a sectional view of an impact tool of the invention according to a third embodiment,

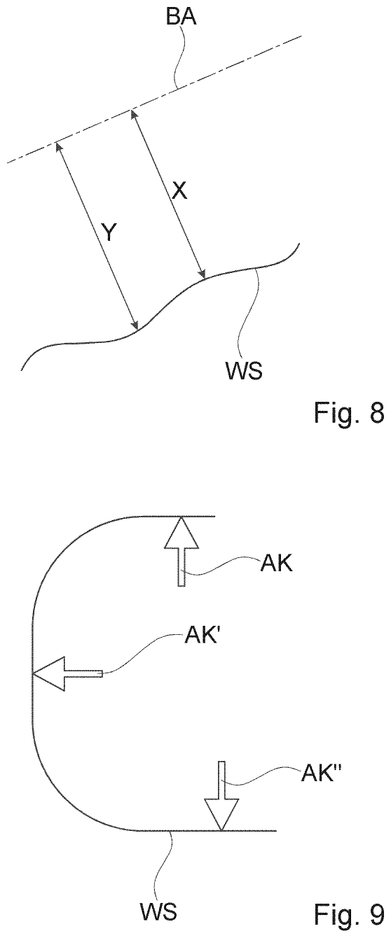

FIG. 8 is a first schematic representation of the use of an impact tool according to the invention,

FIG. 9 is a second schematic illustration of the use of an impact tool according to the invention,

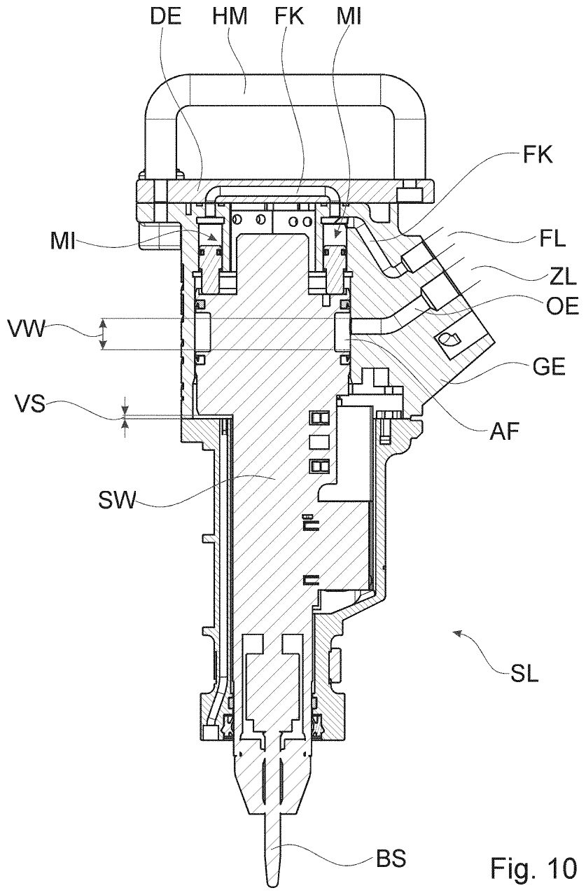

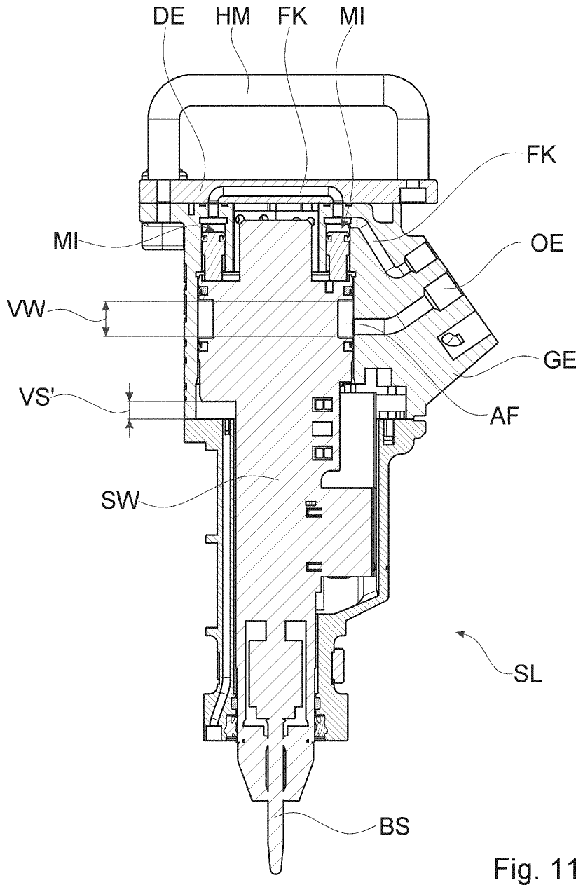

FIG. 10 is a sectional view of an impact tool of the invention according to a fourth embodiment in a first position of the impact mechanism, and

FIG. 11 is a sectional view of the impact tool according to FIG. 10 in a second position of the impact mechanism.

In the figures, the same or functionally equivalent components are provided with the same reference numerals.

FIG. 1 shows a three-dimensional representation of an impact tool SL in a perspective side view. The impact tool SL has a housing GE, in the interior of which there is an impact mechanism SW. On the side of the impact tool SL facing a workpiece WS there is a machining tip BS which can be designed, for example, in the form of a chisel having a rounded end. The machining tip BS is periodically set in motion in an axial direction AR by an oscillating, preferably periodic, movement of the impact mechanism SW. The periodic movement of the machining tip BS can typically be between 70 Hz and 120 Hz, so that the machining can be carried out in the form of higher-frequency hammering of welds on the workpiece WS. However, the apparatus according to the invention can also be used in other work which requires a pendulous, preferably periodic movement.

In addition to a handle GR arranged on the side, the housing GE has a holding means HM on the side opposite the machining tip BS, which can be designed, for example, in the form of a holding bracket or handle. In the case of robot machining, instead of or in addition to the handle GR, a corresponding receptacle mount would be provided as the holding means HM. A holding force can be exerted by a user in the direction of the machining tip BS along the axial direction AR by means of the holding means HM. In known apparatuses from the prior art, this holding force is transmitted as a contract pressure to the machining tip BS for higher-frequency hammering. According to the invention, however, the impact mechanism SW can be displaced against the housing GE, which can be recognized by the elongated design of the housing opening GO.

The impact mechanism SW can be designed as a pneumatic muscle or as a pneumatic membrane. In other embodiments, however, it would also be possible to use a magnetic or a piezoelectric drive or to design the impact mechanism SW in the form of an air piston. The specific design of the impact mechanism SW is not relevant to the invention, although a pneumatic muscle or a pneumatic membrane is preferred.

In order to better illustrate the displaceability of the impact mechanism SW against the housing GE, reference is made below to FIG. 2, which shows a sectional view of the impact tool SL according to FIG. 1. The section plane is chosen along the axial direction AR in the plane spanned by the holding means HM.

It can be seen in FIG. 2 that the impact mechanism SW can be displaced between a lower stop point AU and an upper stop point AO, wherein the maximum stroke is identified as the travel VW. The impact mechanism SW, together with the machining tip BS, is only shown schematically as a unit. To move the impact mechanism SW inside the housing GE, several guides FR are provided, which can be arranged, for example, in the area above the lower stop point AU and in the area in the direction of the machining tip BS. Furthermore, a means MI for generating a contact pressure AK is arranged on the side of the housing GE opposite the holding means HM between the impact mechanism SW and the housing GE. The means MI for generating the contact pressure AK can be provided, for example, as a mechanical spring element, so that the impact mechanism SW bears against the lower stop point AU of the housing GE before the machining begins. In order to generate a certain contact pressure AK, a holding force HK is first exerted using the holding means HM, as will be explained below with reference to FIGS. 3 to 5, such that, as shown in FIG. 3, the impact mechanism SW is moved away from the lower stop point AU by one prestressing path VS. As soon as this prestressing path VS has a minimum value, the minimal contact pressure AK is reached by means of the spring of the means MI for generating the contact pressure AK.

The contact pressure AK of the impact mechanism SW thus corresponds to the spring force of the means MI. In order to be able to change the contact pressure AK, the spring element of the means MI could, for example, be prestressed differently by means of a corresponding turntable (not shown in FIG. 3) which would make it possible, for example, to adjust the contact pressure AK manually. In other embodiments, the impact mechanism SW can also be activated automatically, wherein by reaching the minimal prestressing path VS via a starting circuit ST, which is indicated schematically in FIG. 3 as a switch, the impact mechanism SW is automatically activated.

In FIG. 4, the impact mechanism SW is at a further distance from the lower stop point AU due to increasing holding force HK or changing distance between the machining tip BS and workpiece WS. However, this first travel VW′ is still in an area in which the impact mechanism SW can work without hitting the upper stop element. According to FIG. 4, the larger first prestressing path VS' is also connected to a larger contact pressure AK, since the spring element of the means MI typically generates displacement-dependent spring forces.

FIG. 5 shows the situation in which the impact mechanism SW is deflected even further from the lower stop point AU almost to the upper stop point AO. As already mentioned in connection with FIG. 4, this can be caused both by an increasing holding force HK on the holding means HM or by a decreasing distance between the machining tip BS and workpiece WS. As soon as the deflection, which is identified in FIG. 5 by means of the second prestressing path VS″, reaches a value which no longer allows the impact mechanism SW to work safely, this could activate a switch SC, for example, so that an optical display, indicated schematically in FIG. 5 on the side of the housing GE, is activated. The display AZ could, for example, be a light-emitting diode that indicates the deflection up to the second prestressing path VS″ by means of a signal color. The second prestressing path V″ corresponds to a second travel VW″.

In other embodiments, reaching the determined minimal prestressing path VS, as shown in FIG. 3, could also be signaled by means of the display AZ or a further display AZ (not shown). Instead of an optical display using a light-emitting diode, an acoustic display would also be conceivable. Likewise, an electrical signal could also be emitted instead of a display AZ, which would be particularly advantageous when using the impact tool SL in a robot or a robot arm. The optimal working area corresponds to the area of the complete travel VW reduced by the travel distance VW′ and the prestressing travel VS′.

When machining, for example, along or around an edge on the workpiece WS, a brief placement of the machining tip BS could result in the prestressing path VS falling below the minimum. In the embodiment according to FIG. 3, the start circuit ST would therefore ensure that the impact mechanism SW was switched off. However, since frequent switching on and off of the impact mechanism SW would be disruptive in such applications, a hand switch HS can be provided which allows a user to overwrite the switching off of the start circuit ST. Instead of a hand switch HS, an electrical signal can also be provided here, which is generated, for example, by a control system of a robot or a robot arm or is stored in the path program of the machining path.

The embodiment of the invention previously shown in connection with FIGS. 1 to 5 uses a simple spring as means MI for generating the contact pressure AK, wherein said spring can be mechanically or automatically adjusted, for example. Some further embodiments are shown below, which differ with regard to the configuration of the means MI for generating the contact pressure AK.

FIG. 6 shows the impact tool SL in a further embodiment, wherein the contact pressure AK between the housing GE and the impact mechanism SW is adjustable here. The means MI is equipped with a pneumatic spring element in the form of air bellows, wherein the air bellows of the means MI is connected to a pressure valve DV via a fluid channel FK and a fluid line FL. The pressure valve DV is adjustable and is fed on the input side via a further fluid line FL′ from a pneumatic pump FP. It is thus possible, via the adjustability of the pressure valve DV, which can be done both manually and automatically, to design the contact pressure AK of the means MI accordingly. In addition to the example shown with a pneumatic spring element, adjustability is also possible with mechanical, hydraulic, or electrical means MI. The air bellows LB can accordingly be replaced by other spring elements.

A further embodiment of the invention is explained below with reference to FIG. 7. In contrast to the air bellows LB, the embodiment according to FIG. 7 has an air piston LK, which is also connected to an adjustable pressure control valve DV via a fluid channel FK and a fluid line FL. The pressure control valve DV is in turn connected to a pneumatic pump FP via the further fluid line FL′. The adjustability of the pressure control valve DV is carried out according to the embodiment according to FIG. 7 via an inclination sensor NS, which in its simplest form is only designed as an inclination switch in order to be able to recognize overhead work. In yet other configurations, the inclination sensor NS can output the spatial arrangement of the impact tool SL. Since, depending on the spatial arrangement, the weight of the impact tool SL is added to or subtracted from the holding force HK, compensation of the contact pressure AK can be achieved by means of the inclination sensor independently of the spatial arrangement of the impact tool SL. A suitable control circuit is provided for this purpose, which can be implemented, for example, as a PLC control. The control circuit RE is only schematically shown in FIG. 7.

The controllability of the means MI for generating the contact pressure AK can be expanded with additional data. For example, in the case of automated machining using a robot or a robot arm, a current coordinate value of the machining path could be generated, which is then passed on to the control circuit RE.

In this way, a force compensation with regard to the contact pressure or a path compensation with regard to varying distances between the machining tip BS and the workpiece WS can also be generated for a given machining path.

This is explained again with reference to FIGS. 8 and 9.

The intended machining path BA, for example of a robot or a robot arm, is illustrated in the schematic illustration according to FIG. 8. With a contour of the workpiece WS that is not resolved, for example, by the machining path BA, the distance between the machining tip BS and the workpiece WS would change, which would result in different prestressing paths. Accordingly, the contact pressure AK or the available stroke with respect to the prestressing path also changes. The control circuit RE can compensate for the different distances X and Y shown in FIG. 8, wherein said compensation is caused by the contour of the workpiece WS.

A workpiece WS is shown in FIG. 9, in which the machining path is carried out overhead in a first position, as is illustrated by the contact pressure AK. In a second position, which is characterized by the contact pressure AK′, machining takes place in the horizontal direction. The third machining position according to the contact pressure A″ takes place in the direction of the floor. Consequently, the weight of the impact mechanism with respect to the contact pressure AK and the contact pressure AK″ has different effects, since the weight force with respect to the impact mechanism SW acts once in the direction of the contact pressure and once counter to it. With regard to the contact pressure AK′, an increased friction in the impact mechanism SW would be noticeable, since an increased friction or at least a changed friction with respect to the guides FR must be expected here. Through the regulation by means of the regulation, the pressure valve DV can now be changed on the basis of the inclination sensor NS in such a way that the contact pressure remains the same or approximately the same for all three positions AK, AK′, and AK″. This corresponds to a force compensation with regard to the regulation of the contact pressure AK.

FIG. 10 shows a further embodiment of the impact tool SL. The representation in FIG. 10 takes place in a sectional view similar to the representation in FIG. 2. In contrast to the previous exemplary embodiments, a supply line ZL for fluid supply, for example for a pneumatic muscle, is connected directly to the housing GE. In order to be able to displace the impact mechanism SW between the lower stop point and the upper stop point, the supply line extends via the channel-shaped opening OE to a receptacle AF formed in the axial direction AR. The receptacle AF is dimensioned such that the channel-shaped opening OE can receive fluid via the supply line ZL both when the impact mechanism is positioned near the lower stop point AU and when the impact mechanism is positioned in the region of the upper stop point AO. Accordingly, an uninterrupted connection to the supply line ZL is possible. The receptacle AF is preferably designed in an annular shape in order to allow a simple seal to the area above or below when the impact mechanism SW moves.

It can also be seen from FIG. 10 that the fluid line FL can be passed on to the corresponding pneumatically controllable means MI via the fluid channel FK, which can also be carried out, for example, by a cover DE, which forms part of the housing GE. The distribution of the fluid via the fluid channels FK in the interior of the cover DE makes it possible to provide a plurality of means MI without having to provide additional lines in the interior of the housing GE. The part of the fluid channel FK assigned to the fluid line FL must in turn be arranged in such a way that the impact mechanism SW can be displaced over the entire area between the lower stop point AU and the upper stop point AO. A displacement of the impact mechanism SW in the direction of the upper stop point AO is shown in FIG. 11. It can be seen that both the supply line ZL and the fluid line FL can provide a corresponding supply.

The embodiment of the impact tool SL shown in FIGS. 10 and 11 allows for a particularly compact structure, which is also low-maintenance, since, for example, by removing the cover DE on the housing GE or by removing parts of the two-part housing GE, for example, access to the pneumatically adjustable means MI and the impact mechanism SW is possible. In particular, the complete impact mechanism SW can be replaced, which leads to a significant improvement in ease of maintenance.

The features indicated above and in the claims, as well as the features which may be seen in the figures, may be advantageously implemented both individually as well as in various combinations. The invention is not limited to the exemplary embodiments described, but may be modified in many ways within the scope of expert knowledge.

### LIST OF REFERENCE NUMERALS

AF receptacle
AK contact pressure
AK′ contact pressure
AK″ contact pressure
AO upper stop point
AR axial direction
AU lower stop point
AZ display
BA machining path
BS machining tip
DE cover
DV pressure control valve
DV pressure valve
FK fluid channel
FL fluid line
FL′ fluid line
FP pneumatic pump
FR guides
GE housing
GO housing opening
GR handle
HK holding force
HM holding means
HS hand switch
LB air bellows
LK air piston
MI means
NS inclination sensor
OE opening
RE control circuit
SC switch
SL impact tool
ST start circuit
SW impact mechanism
VS prestressing path
VS' prestressing path
VS″ prestressing path
VW travel
VW′ travel
WS workpiece
ZL supply line

1. An impact tool for machining workpieces having an impact mechanism (SW) which is arranged in a housing (GE) and is suitable for transmitting an oscillating movement to a machining tip (BS) arranged in an axial direction (AR), wherein the impact mechanism (SW) can be displaced against the housing (GE) between a lower stop point (AU) and an upper stop point (AO) in the axial direction (AR), wherein a means (MI) for generating a constant or variable contact pressure (AK) of the machining tip (BS) is arranged between the housing (GE) and the impact mechanism (SW), such that after a prestressing path of the impact mechanism (SW) from the lower stop point (AU), the machining tip (BS) is additionally subjected to the contact pressure (AK).

2. The impact tool according to claim 1, wherein a holding means (HM), preferably in the form of a handle, for generating a holding force (HK), is connected to the housing (GE) and is arranged on the side opposite the machining tip (BS).

3. The impact tool according to claim 2, wherein the means (MI) for generating the contact pressure (AK) is arranged on the opposite side of the housing (GE) with respect to the holding means (HM).

4. The impact tool according to claim 1, wherein the impact mechanism (SW) is designed as a pneumatic muscle or membrane, has a magnetic or piezoelectric drive, or is designed in the form of an air piston.

5. The impact tool according to claim 1, wherein the means (MI) for generating the contact pressure is provided with a mechanical, a piezoelectric, a magnetic, or a hydraulic spring element.

6. The impact tool according to claim 1, wherein the means (MI) for generating the contact pressure is designed pneumatically in the form of an air spring.

7. The impact tool according to claim 1, wherein the means (MI) for generating the contact pressure can be regulated via a regulating circuit (RE).

8. The impact tool according to claim 7, wherein an inclination sensor (NS) is provided which transmits a spatial orientation of the impact tool (SL) to the control circuit (RE), such that a constant force application of the machining tip (BS) can be generated independently of the spatial orientation of the impact tool (SL).

9. The impact tool according to claim 1, wherein one or more optical or acoustic displays (AZ) of the prestressing path are provided within the lower stop point (AU) and the upper stop point (AO).

10. The impact tool according to claim 1, comprising an automatic start circuit which activates the impact mechanism (SW) when a minimally specified prestressing path is reached.

11. The impact tool according to claim 10, wherein a hand switch is provided which overwrites the automatic start circuit with respect to the switching off of the impact mechanism (SW).

12. The impact tool according to claim 1, wherein the impact mechanism (SW) is provided with at least one supply line (ZL) which generates the oscillating movement via a suitable control.

13. The impact tool according to claim 12, wherein the supply line (ZL) can be displaced together with the impact mechanism (SW) relative to the housing (GE).

14. The impact tool according to claim 12, wherein the supply line (ZL) is fixed relative to the housing (GE).

15. The impact tool according to claim 14, wherein the supply line (ZL) is connected to an opening (OE) on the housing (GE) which opens into a receptacle (AU) on the impact tool (SW), said receptacle being arranged in the axial direction and being dimensioned in such a way that an uninterrupted connection with the supply line (ZL) can be achieved between the lower stop point (AU) and the upper stop point (AO).
